(19) United States
(12) Patent Application Publication
(10) Pub. No.: US 2013/0150108 A1
(43) Pub. Date: Jun. 13, 2013

(54) DEVICE-TO-DEVICE COMMUNICATION METHOD BASED ON CELLULAR COMMUNICATION SYSTEM

(71) Applicants: Mi Jeong YANG, Daejeon (KR); Kwang Ryul JUNG, Daejeon (KR); Ae Soon PARK, Daejeon (KR)

(72) Inventors: Mi Jeong YANG, Daejeon (KR); Kwang Ryul JUNG, Daejeon (KR); Ae Soon PARK, Daejeon (KR)

(73) Assignee: Electronics and Telecommunications Research Institute, Daejeon (KR)

(21) Appl. No.: 13/546,247

(22) Filed: Jul. 11, 2012

(30) Foreign Application Priority Data
Dec. 9, 2011 (KR) 10-2011-0131944

(51) Int. Cl. H04W 72/04

(52) U.S. Cl. 455/509

(57) ABSTRACT

Provided is a device-to-device (D2D) communication method based on a cellular communication system. The D2D communication method is based on a hierarchical D2D communication structure configured with a representative terminal and belonging terminals. Accordingly, the D2D communication method can be applied to various applications and business models. Also, a belonging terminal performs data communication only with an adjacent representative terminal due to a middle gathered structure through the representative terminal, so that the D2D communication method can be applied to an application requiring low power consumption. Further, the D2D communication method can be used as a solution for a Proxy machine-to-machine (M2M) device due to powerful security of mobile communication compared to that of a sensor network, reliability of data transmission, and speed of data transmission resulting from low latency.

### CLAIM FOR PRIORITY

This application claims priority to Korean Patent Application No. 10-2011-0131944 filed on Dec. 9, 2011 in the Korean Intellectual Property Office (KIPO), the entire contents of which are hereby incorporated by reference.

### BACKGROUND

1. Technical Field

Example embodiments of the present invention relate in general to the field of cellular communication, and more specifically to a device-to-device communication method based on a cellular communication system, which is easily applicable to various applications and business models.

2. Related Art

Device-to-device (hereinafter referred to as “D2D”) communication in a cellular communication system is a technology in which terminals adjacent to each other under a cellular communication network set up a D2D link using a cellular interface, and directly exchange data through the D2D link. The D2D technology is aimed at, without increasing cost for infrastructures, improving transmission speed for cell-edge users, supporting connection to a cellular network for terminals in a shadow region, and increasing system capacity by reducing interference. The D2D technology is expected to be an underlying technology for Internet of Things (IOT) or sensor networks in the future.

Specifically, the D2D technology in a cellular communication system is becoming more important due to its advantages of large cell coverage, superior security, etc. compared to conventional technology such as WiFi Direct, Bluetooth, and Zigbee, and is likely to be standardized by the 3rd Generation Partnership Project (3GPP). However, the D2D technology in a cellular communication system currently considers only data communication through D2D communication between two equivalent terminals.

The D2D communication between two equivalent terminals provides some basic advantages of D2D communication such as improvement of transmission speed, increase in system capacity, etc., but basically takes only functions of voice calling, data transmission/reception, etc. between two terminals into consideration. Thus, there are some limitations in developing various applications and new business models.

As a variety of applications, there are some cases in which a terminal which enters a department store receives a variety of information such as store guidance, best route recommendation coupled with necessary items, sale items, and price comparison, through D2D communication and in which a terminal which enters a museum receives guidance for exhibition halls of the museum, and relevant data and details for each exhibit, etc. Other applications include smart metering in which a variety of information of a metering terminal is collected and processed to be transmitted to a server, home automation, and factory automation.

In the applications mentioned above, a new D2D communication method is required to improve the overall system efficiency beyond the basic advantages of D2D communication such as the improvement of transmission speed and the increase in system capacity, etc.

For example, since there are an excessively large number of terminals for collecting data in the D2D communication for smart metering, a method of reducing the congestion or the overhead of control information signaling caused by the terminals may be required. In some specific applications, terminals have very limited battery power, and power saving may be the most important factor.

### SUMMARY

Accordingly, example embodiments of the present invention are provided to substantially obviate one or more problems due to limitations and disadvantages of the related art.

Example embodiments of the present invention provide a device-to-device (D2D) communication method based on a hierarchical structure configured with a representative terminal and belonging terminals in order to be applied to various applications and business models, and more specifically, provide data transmission methods from a representative terminal to a belonging terminal and from a belonging terminal to a representative terminal, which are appropriate for a service model using a user terminal-type of belonging terminal.

Example embodiments of the present invention also provide a D2D communication method based on a hierarchical structure configured with a representative terminal and belonging terminals in order to be applied to various applications and business models, and more specifically, provide a method for a representative terminal to receive data from a belonging terminal and a method for a representative terminal to transmit data to a belonging terminal, which are appropriate for a service model using a low power sensor node-type of belonging terminal.

In some example embodiments, a D2D communication method in which a belonging terminal subordinate to a representative terminal transmits data to the representative terminal, includes: performing pairing with the representative terminal; transmitting a request for scheduling to a serving cell base station of the belonging terminal when a data transmission to the paired representative terminal is required; receiving an approval for scheduling from the serving cell base station; and performing the data transmission to the representative terminal based on the approval for scheduling.

Performing the pairing may include transmitting, at the belonging terminal, an identifier acquired by attaching to the serving cell base station to a server which manages pairing information, and receiving the identifier of the representative terminal from the server.

The request for scheduling may be a buffer status report (BSR), the approval for scheduling may be an approval for scheduling through a physical downlink control channel (PDCCH), and performing the data transmission may include transmitting, at the belonging terminal, a physical uplink shared channel (PUSCH) using radio resources specified by the approval for scheduling.

The data which the belonging terminal transmits to the representative terminal may include content for the belonging terminal to request—information customized for the belonging terminal from the representative terminal.

In other example embodiments, a D2D communication method for a representative terminal to which at least one belonging terminal is subordinate to transmit data to the belonging terminal, includes: performing pairing with the belonging terminal; transmitting a request for scheduling to a serving cell base station of the representative terminal when a data transmission to the paired belonging terminal is required; receiving an approval for scheduling from the serving cell base station; and performing the data transmission to the belonging terminal based on the approval for scheduling.

Performing the pairing may include registering, at the representative terminal, to a server which manages pairing information as a representative terminal with an identifier acquired by attaching to the serving cell base station, and pairing with the belonging terminal which acquires the identifier of the representative terminal from the server.

The request for scheduling may be a BSR, the approval for scheduling may be an approval for scheduling through a PDCCH, and the data transmission is performed through a physical uplink shared channel (PUSCH) by using radio resources specified by the approval for scheduling.

The representative terminal may broadcast broadcasting data stored in the representative terminal to the belonging terminals using a group identifier in the D2D communication method.

The representative terminal may serve as an application server which provides an application to the belonging terminals.

In still other example embodiments, a D2D communication method for a representative terminal to which at least one belonging terminal is subordinate to receive data from the belonging terminal, includes transmitting a request for scheduling to a serving cell base station to which the representative terminal belongs when there is data to be received from the belonging terminal; receiving an approval for scheduling from the serving cell base station; and receiving the data from the belonging terminal based on the approval for scheduling.

The D2D communication method may further include collecting the data received from the belonging terminal, processing the collected data through manipulation and analysis, and transmitting the processed information to a data collecting server.

The request for scheduling may be a BSR, the approval for scheduling may be an approval for scheduling through a PDCCH, and receiving the data may include receiving a PUSCH transmitted by the belonging terminal using radio resources specified by the approval for scheduling.

In still other example embodiments, a D2D communication method for a representative terminal to which at least one belonging terminal is subordinate to transmit data to the belonging terminal includes: transmitting a request for scheduling to a serving cell base station of the representative terminal when a data transmission to the belonging terminal is required; receiving an approval for scheduling from the serving cell base station; and performing the data transmission to the belonging terminal based on the approval for scheduling.

The data transmission may be a transmission of data including control information on the belonging terminal.

The request for scheduling may be a BSR, the approval for scheduling may be an approval for scheduling through a PDCCH, and performing the data transmission may include transmitting, at the representative terminal, a PUSCH using radio resources specified by the approval for scheduling.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram describing a concept for a method of central-controlled device-to-device (D2D) communication based on a cellular communication system.

FIG. 2 is a conceptual diagram describing a concept for a D2D communication method based on a cellular communication system in accordance with example embodiments of the present invention.

FIG. 3 is a flowchart describing a data transmission method of a belonging terminal applicable to a Type 1 service model among D2D communication methods in accordance with example embodiments of the present invention.

FIG. 4 is a flowchart describing a data transmission method of a representative terminal applicable to a Type 1 service model among D2D communications methods in accordance with example embodiments of the present invention.

FIG. 5 is a message sequence chart describing a data transmission/reception method applied to a Type 1 service model among D2D communications in accordance with example embodiments of the present invention.

FIG. 6 is a message sequence chart describing a pairing process between belonging terminals and a representative terminal in a Type 1 service model among D2D communication methods in accordance with example embodiments of the present invention.

FIG. 7 is a flowchart describing a data reception method of a representative terminal applicable to a Type 2 service model among D2D communication methods in accordance with example embodiments of the present invention.

FIG. 8 is a message sequence chart describing a data reception method of a representative terminal in a Type 2 service model among D2D communication methods in accordance with example embodiments of the present invention.

FIG. 9 is a flowchart describing a data transmission method of a representative terminal applicable to a Type 2 service model among D2D communication methods in accordance with example embodiments of the present invention.

FIG. 10 is a message sequence chart describing a data transmission method of a representative terminal in a Type 2 service model among D2D communication methods in accordance with example embodiments of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” used herein may refer to a mobile station (MS), a user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various examples of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an internet home appliance capable of wireless internet access and browsing, and also portable units or terminals having a combination of such functions, but a terminal is not limited thereto.

The term “base station” used herein generally denotes a fixed point communicating with a terminal, and may be referred to as a Node-B, an eNode-B, a base transceiver system (BTS), an access point, a relay, and a femto-cell, etc.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the accompanying drawings. To aid in understanding the present invention, like numbers refer to like elements throughout the description of the figures, and the description of the same component will not be reiterated.

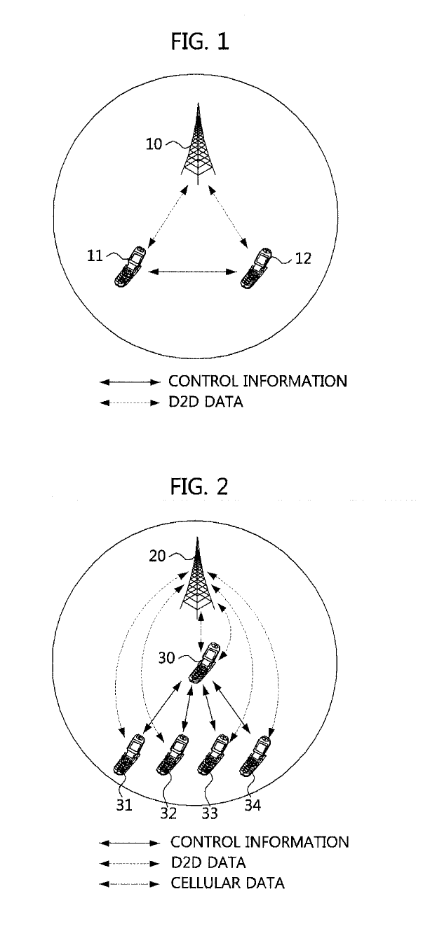

FIG. 1 is a conceptual diagram describing a concept for a central-controlled device-to-device (D2D) communication method based on a cellular communication system.

Referring to FIG. 1, D2D terminals 11 and 12 are allocated resources under the control of a base station 10 and perform data communication, i.e., D2D communication, between them based on the allocated resources.

Currently, only the data transmission between two equivalent terminals through D2D communication is considered for the D2D technology based on a cellular communication system. That is, the terminals 11 and 12 performing D2D communication in FIG. 1 are controlled by control information exchanged with the base station 10 without a representative-belonging relationship. The D2D communication between two equivalent terminals may provide basic advantages of D2D communication such as the improvement of transmission speed and the expansion of system capacity. However, the D2D communication between two equivalent terminals basically takes only the functions of voice calling, data transmission/reception, etc. between two terminals into consideration, and thus is difficult to be applied to various applications and development of new business models.

FIG. 2 is a conceptual diagram describing a concept for a D2D communication method based on a cellular communication system in accordance with example embodiments of the present invention.

Referring to FIG. 2, the basic concept of the D2D communication method in accordance with example embodiments of the present invention may have a service format hierarchically configured with belonging terminals 31, 32, 33, and 34 and a representative terminal 30 commanding the belonging terminals.

In this case, all terminals, including the representative terminal and the belonging terminals, may be controlled by a base station 20. Each of the representative terminal 30 and the belonging terminals 31, 32, 33, and 34 may be allocated radio resources for D2D data transmission and use the allocated resources for D2D communication under the control of the base station 20. In other words, the representative terminal 30 and the belonging terminals 31, 32, 33, and 34 may be allocated radio resources by control information exchanged with the base station and perform D2D data communication using the allocated resources. The representative terminal may perform cellular communication with the base station. Although it is not shown in FIG. 2, the belonging terminals, depending on their types (that is, if the belonging terminals are a user terminal capable of cellular communication), may also perform cellular communication. In addition, although the belonging terminals perform D2D communication with the representative terminal in FIG. 2, D2D communication between the belonging terminals may be possible depending on the types of the belonging terminals.

A D2D representative terminal in accordance with example embodiments of the present invention may have functions as below.

1) collecting data from belonging terminals, processing the collected information, and forwarding the processed information to a server

2) transmitting data to each belonging terminal

3) broadcasting data to all belonging terminals

4) setting environment and control of belonging terminals

The D2D communication in accordance with example embodiments of the present invention may be mainly applied to the following two service models, depending on the types of belonging terminals.

A first service model corresponds to a case in which a belonging terminal is a user device type (referred to below as a “Type 1 service model”), and exists in the form of a terminal carried by a user or a manager-type sensor node capable of power supply, and a representative terminal to which the belonging terminal belongs can change frequently due to the mobility of the belonging terminal.

As a specific service case of the Type 1 service model mentioned above, there is a case in which a belonging terminal which enters a department store receives a variety of information such as store guidance, best route recommendation coupled with necessary items, sale items, and price comparison information, by connecting to a representative terminal of the department store. As another specific service case of the Type 1 service model mentioned above, there is a case in which a belonging terminal which enters a museum receives guidance for exhibition halls of the museum, relevant data and details for each exhibit, etc. from a representative terminal.

A second service model corresponds to a case in which a belonging terminal is a low-power sensor node (referred to below as a “Type 2 service model”), which is not easy for people to directly manage and is a fixed node having no mobility. In such an application, since power supply to a sensor node is the most urgent problem, a D2D communication method considering the power supply is required.

Specific service cases of the Type 2 service model mentioned above include smart metering in which a representative terminal collects and processes a variety of information of metering terminals (belonging terminals) and transmits the information to a server, an application of home automation (home network) in which direct communication is performed between a belonging terminal and a representative terminal inside a home and cellular communication is performed outside the home, factory automation (elimination of inconvenience in monitoring pressure and temperature, reduction of maintenance cost, and provision of reliable data transmission), etc.

In example embodiments of the present invention, functions of a representative terminal and belonging terminals may be configured as follows according to the two service models.

1) Type 1 Service Model

A belonging terminal may be configured to perform pairing with a representative terminal (generally, a representative terminal adjacent to the belonging terminal) and direct communication with the representative terminal, as needed. In the Type 1, the belonging terminal may directly request resources for D2D communication from a base station because of little limitation on a battery of the belonging terminal.

The representative terminal may be configured to provide a management function for belonging terminals which currently belong to the representative terminal, serve as an application server of the belonging terminals, and therefore, provide a required application and data by request of the belonging terminals.

Whenever needed, the belonging terminals may use a service through the representative terminal and also a service based on conventional cellular communication by communicating with the base station.

When the representative terminal broadcasts information to all of the belonging terminals which belong to the representative terminal, the representative terminal may use a group identifier (referred to below as a “group radio network temporary identifier (RNTI)”) and provide information customized according to terminals to each belonging terminal through 1:1 communication.

2) Type 2 Service Model

A belonging terminal, which is a fixed type, may be generally configured to perform D2D communication only with a predetermined representative terminal. That is, a pairing process between the belonging and representative terminals may not generally be required in the case of the Type 2. Since the belonging terminal may operate only in a discontinuous reception (DRX) mode, battery consumption is minimized. DRX is a function of controlling a terminal to stop the receiving operation and to sleep in order to reduce the power consumption of the terminal.

The representative terminal may transmit a request for allocation of radio resources for D2D communication to a base station instead of the belonging terminal when each belonging terminal requires D2D communication, and the belonging terminal may only receive radio resource allocation information from the base station to use for D2D communication.

It is assumed that the time for the representative terminal triggering the request for allocation of radio resources to the base station instead of a belonging terminal is preset on the representative terminal and each belonging terminal.

The representative terminal may provide a management function for belonging terminals and receive data transmitted from the belonging terminals to forward to the server immediately or after processing.

Scheduled collection and processing of management-type data may be performed by the representative terminal. However, emergencies and unscheduled events may be processed as exceptional situations using cellular communication between a belonging terminal and the base station.

The Type 2 may be applied to service models such as a sensor network and smart metering which are based on a mobile communication network.

A D2D communication method which may be applied to the Type 1 and Type 2 service models mentioned above will be described in terms of a data transmission and reception method between a belonging terminal and a representative terminal. In the following, data transmission by the belonging terminal refers to a case in which the belonging terminal transmits data to the representative terminal using D2D communication, and also conversely a case in which the representative terminal receives data from the belonging terminal using D2D communication. Likewise, data reception by the belonging terminal may refer to data transmission by the representative terminal. Therefore, the description may be based on the transmission and reception of data by one side of the belonging and representative terminals for convenience of description, which should be understood as implicating the reception and transmission of data by the other side.

D2D Communication Method of Type 1 Service Model

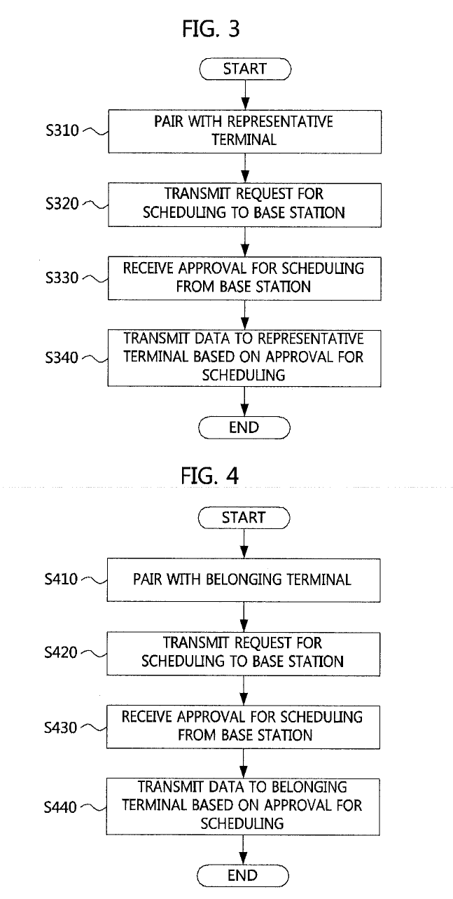

FIG. 3 is a flowchart describing a data transmission method of a belonging terminal applicable to the Type 1 service model among D2D communication methods in accordance with example embodiments of the present invention. FIG. 4 is a flowchart describing a data transmission method of a representative terminal in the same situation as in FIG. 3.

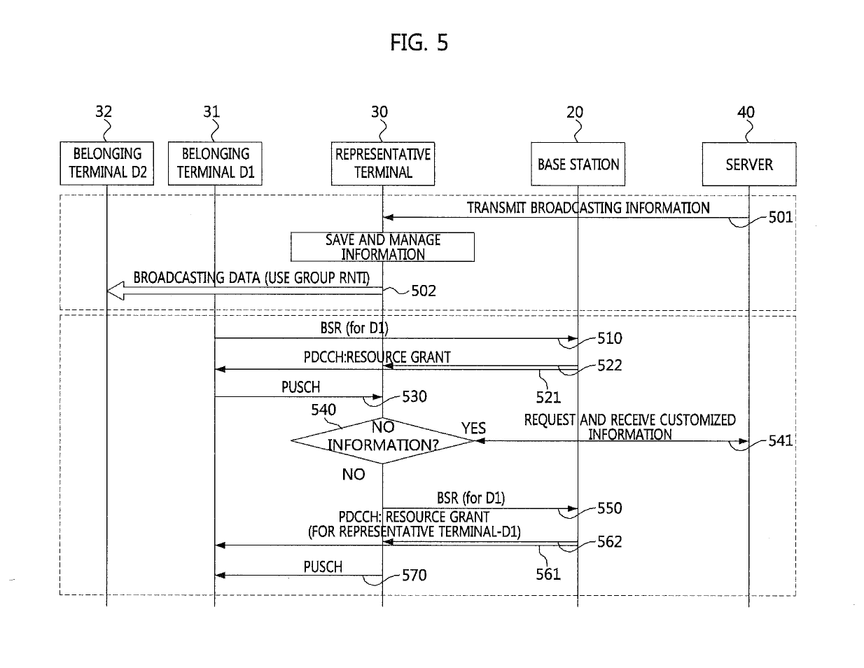

Meanwhile, FIG. 5 is a message sequence chart describing a data transmission/reception method of the Type 1 service model among D2D communication methods in accordance with example embodiments of the present invention. In other words, FIG. 5 is a message sequence chart describing overall data transmission/reception performed in the Type 1 service model among a representative terminal, belonging terminals, a base station, and server components.

A D2D communication method in accordance with example embodiments of the present invention will be described below with reference to FIGS. 3, 4 and 5. Here, different parts of FIG. 5 may be partially referred to in order to describe the data transmission/reception methods represented in FIG. 3 and FIG. 4.

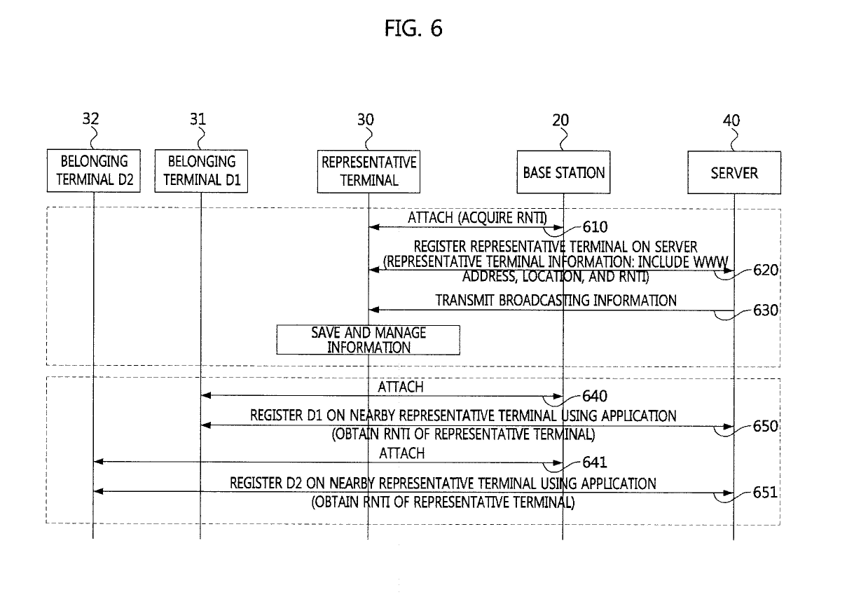

Referring to FIG. 3, an example of a D2D communication method according to an example embodiment of the present invention may include, when a belonging terminal wants to transmit data to a representative terminal, performing pairing with the representative terminal (S310), transmitting a request for scheduling to a serving cell base station of the belonging terminal when a data transmission to the paired representative terminal is required (S320), receiving an approval for scheduling from the serving cell base station (S330), and transmitting the data to the representative terminal based on the approval for scheduling (S340). The step of performing pairing with the representative terminal (S310) will be described later using FIG. 6 and first, step 320 will be described assuming that the belonging terminal has been already paired with the representative terminal.

Referring to FIG. 5 in parallel, when there is data to transmit to a representative terminal 30, a belonging terminal 31 transmits a request for scheduling to the representative terminal 30 (510). Here, the request for scheduling may be a buffer status report (BSR) which is a request for allocation of radio resources. That is, the BSR transmission 510 in FIG. 5 may refer to a request for scheduling in step 320 described in the flowchart of FIG. 3.

Next, the base station determines radio resources to be used for the belonging terminal transmitting the data to the representative terminal and transmits the determined radio resource allocation information (a resource grant) to the belonging terminal and the representative terminal respectively through a physical downlink control channel (PDCCH) (521 and 522). In this case, the belonging terminal receives a resource grant that the data is to be transmitted using the allocated radio resources, and the representative terminal receives a resource grant that the data is to be received using the allocated radio resources. That is, the resource grant in FIG. 5 may refer to the approval for scheduling in step 330 described in the flowchart of FIG. 3.

In this way, D2D communication in which the belonging terminal transmits data to the representative terminal using the radio resources allocated by the base station is realized (530). That is, the belonging terminal transmits data to the representative terminal through a data channel (physical uplink shared channel (PUSCH)) which uses the allocated radio resources.

In this case, the data which the belonging terminal transmits to the representative terminal may include content that requests customized information specified for the belonging terminal depending on the type of applications. For example, the data which the belonging terminal transmits to the representative terminal may include content requesting customized information (product information according to a customer's preference, sale information, discount information affiliated with a network provider, etc.) based on information on the belonging terminal which enters a shopping center (e.g., information on an owner of the terminal, information on a network provider to which the terminal subscribes, and a type of the terminal)

It is determined whether the representative terminal holds the information (540). When the representative terminal already holds the information, the representative terminal immediately transmits the information to the belonging terminal by a data transmission method of the representative terminal (i.e., data reception of the belonging terminal) which will be described below referring to FIG. 4. On the other hand, when the representative terminal does not hold the information, the representative terminal requests and receives the information from a server (541), and then transmits the information to the belonging terminal using the data transmission method of the representative terminal to be described below referring to FIG. 4.

Referring to FIG. 4, an example of a D2D communication method according to example embodiments of the present invention may include, when a representative terminal wants to transmit data to a belonging terminal, performing paring with the belonging terminal (S410), transmitting a request for scheduling to a serving cell base station of the representative terminal when a data transmission to the paired belonging terminal is necessary (S420), receiving an approval for scheduling from the serving cell base station (S430), and transmitting the data to the belonging terminal based on the approval for scheduling (S440). As in the case of FIG. 3, performing the pairing with the belonging terminal (S410) will be described later using FIG. 6, and step 420 will be described first, assuming that the belonging terminal has been paired with the representative terminal.

Referring to FIG. 5 in parallel, when the representative terminal 30 has data to transmit to the belonging terminal 31, the representative terminal transmits a request for scheduling to the base station (550). In this case, the request for scheduling may be a BSR requesting allocation of radio resources. That is, the BSR in FIG. 5 may refer to the request for scheduling in step 420 described in the flowchart of FIG. 4.

The base station determines radio resources to be used for the representative terminal transmitting data to the belonging terminal, and transmits the allocation information on the determined radio resources to the representative terminal and the belonging terminal respectively through control channels (561 and 562). A resource grant that orders the representative terminal to transmit the data using the allocated radio resources is transmitted to the representative terminal, and a resource grant that orders the belonging terminal to receive the data using the allocated radio resources is transmitted to the belonging terminal. In other words, the resource grants may refer to the approval for scheduling in step 430 described in the flowchart of FIG. 4.

The representative terminal 30 may perform D2D data transmission to the belonging terminal 31 on the radio resources allocated by the base station. That is, the representative terminal transmits the data to the belonging terminal through a data channel (PUSCH) using the allocated radio resources. In this case, the data which the representative terminal transmits to the belonging terminal may include the aforementioned customized information requested by the belonging terminal.

Meanwhile, referring to FIG. 5, broadcasting data which the representative terminal 30 receives from a server 40 ordering the representative terminal 30 to transmit to all belonging terminals 31 and 32 (501) may be configured to be transmitted to the belonging terminals through a broadcasting D2D transmission method using a group RNTI (502). Example embodiments of the present invention feature broadcasting D2D transmission between the belonging terminal and the representative terminal using the group RNTI. However, a specific broadcasting D2D transmission method is not included in the scope of example embodiments of the present invention.

FIG. 6 is a message sequence chart describing a pairing process between belonging terminals and a representative terminal in the Type 1 service model among D2D communication methods in accordance with example embodiments of the present invention.

As mentioned above, a representative terminal to which a belonging terminal belongs may change frequently in the Type 1 service model, and accordingly, the pairing process between a belonging terminal and a representative terminal is required. The pairing process between a belonging terminal and a representative terminal in accordance with example embodiments of the present invention may be performed using a server as a mediator.

Referring to FIG. 6, in the paring process in accordance with example embodiments of the present invention, a representative terminal 30 may be allocated with an RNTI by attaching to a base station 20 and registered with the server 40 as a representative terminal.

If the representative terminal has information to be broadcast to all of belonging terminals, the server transmits the information to the representative terminal (630), and the representative terminal stores and manages the broadcasting information.

Meanwhile, the belonging terminals also perform the pairing process of receiving an identifier (RNTI) allocation (640 and 641) by attaching to the base station 20 and acquiring an optimal RNTI of the representative terminal from the server (650 and 651) by connecting to the server through an application program. In this case, the server stores and manages the representative-belonging relationship between terminals while serving as a mediator of RNTI exchange between the belonging terminals and the representative terminal. That is, through the pairing process, the belonging terminals are registered in the representative terminal, and the representative terminal recognizes that the belonging terminals belong to the representative terminal.

D2D Communication Method of Type 2 Service Model

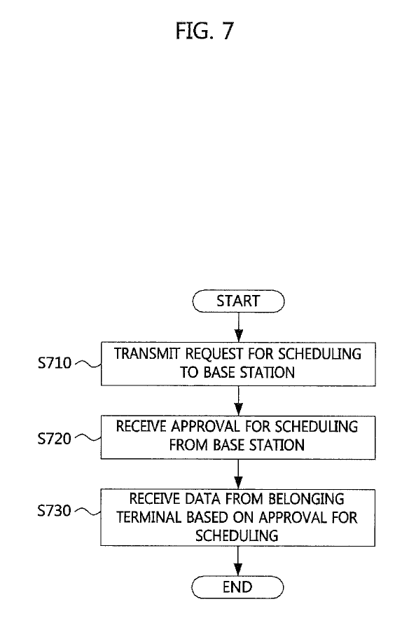

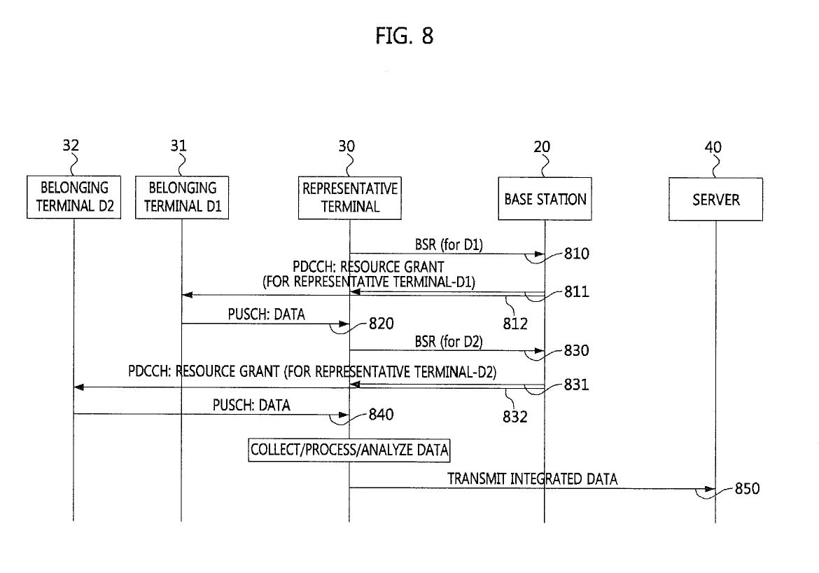

FIG. 7 is a flowchart describing a data reception method of a representative terminal applicable to the Type 2 service model among D2D communication methods in accordance with example embodiments of the present invention. FIG. 8 is a message sequence chart describing a data reception method of a representative terminal in the Type 2 service model among D2D communication methods in accordance with example embodiments of the present invention.

Referring to FIG. 7, the data reception method may include, when a representative terminal to which at least one belonging terminal is subordinate has data to receive from the belonging terminal, transmitting a request for scheduling to a serving cell base station to which the representative terminal belongs (S710), receiving an approval for scheduling from the serving cell base station (S720), and receiving the data from the belonging terminal based on the approval for scheduling (S730).

Referring to FIG. 8 in parallel, in step 710, the representative terminal attaches to the base station and then transmits a BSR to the base station at a scheduled time instead of the belonging terminals in a DRX state (810 and 830). This is intended to reduce power consumption of the belonging terminals because the belonging terminals are generally low-power sensor node-type terminal in the Type 2 service model.

Therefore, the base station determines radio resources to be used for the belonging terminals to transmit data to the representative terminal and transmits information on the determined radio resources (resource grants) to the belonging terminals and the representative terminal respectively through PDCCHs (811, 812, 831, and 832). That is, a resource grant that orders the corresponding belonging terminal to transmit the data using the allocated radio resources is transmitted to the belonging terminal, and a resource grant that orders the representative terminal to receive the data using the allocated radio resources is transmitted to the representative terminal. The belonging terminals transmit the data to the representative terminal through a PUSCH channel on the radio resources allocated by the base station (820 and 840).

Meanwhile, the data received from the belonging terminals may be collected/processed/analyzed to be transmitted to a server in the form of integrated data (850).

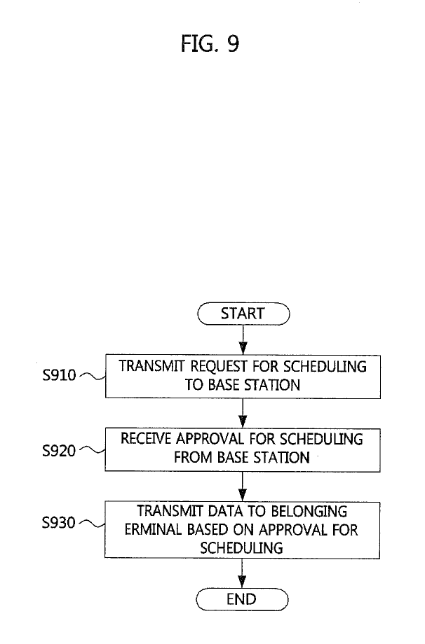

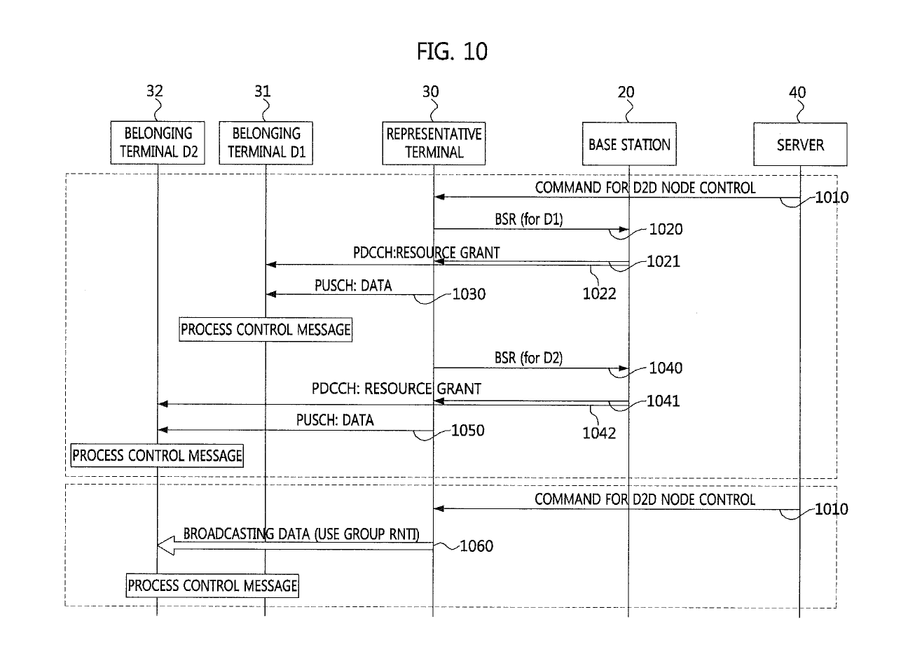

FIG. 9 is a flowchart describing a data transmission method of a representative terminal applicable to the Type 2 service model among D2D communication methods in accordance with example embodiments of the present invention. FIG. 10 is a message sequence chart describing a data transmission method of a representative terminal in the Type 2 service model among D2D communication methods in accordance with example embodiments of the present invention.

Referring to FIG. 9, the data transmission method may include, when a representative terminal needs to transmit data to a belonging terminal, transmitting a request for scheduling to a serving cell base station of the representative terminal (S910), receiving an approval for scheduling from the serving cell base station (S920), and transmitting the data to the belonging terminal based on the approval for scheduling (S930).

In this case, the data transmission to the belonging terminal may mainly refer to a server transmitting control information to the belonging terminal through the base station and the representative terminal. That is, the belonging terminal of the Type 2 service model receives a control message from the server through the representative terminal.

In this case, the server may be a server for managing a sensor network and smart metering which are based on a mobile communication network in the Type 2 service method mentioned above.

In FIG. 10, although it is assumed that a server has data such as a control command, etc. to be transmitted to a belonging terminal, the method may also be applicable when a representative terminal itself has data to be transferred to the belonging terminal. That is, the present invention is not characterized by the location of the source of the data which the representative terminal transmits to the belonging terminal, but by how the representative terminal transmits the data to the belonging terminal.

Referring to FIG. 10 in parallel, a server transmits a control command to be transmitted to belonging terminals to a representative terminal (1010).

The representative terminal which receives the control command transmits a BSR to a base station (1020 and 1040). The base station determines radio resources to be used in data transmission from the representative terminal to the belonging terminals, and transmits information on the determined radio resources (resource grants) to the representative terminal and the belonging terminal through PDCCHs (1021, 1022, 1041, and 1042). That is, a resource grant that orders the representative terminal to transmit the data using the allocated radio resources is transmitted to the representative terminal, and resource grants that order the belonging terminals to receive the data using the allocated radio resources are transmitted to the belonging terminals. The representative terminal transmits a control message to the belonging terminals by the D2D communication using the radio resources allocated by the base station (1030 and 1050). However, when the control message is a broadcasting control message applicable to all of the belonging terminals, the broadcasting control message may be transferred through a broadcasting D2D transmission method using a group RNTI (1060).

D2D communication based on the cellular telecommunication system provides advantages such as security and stability of communication through a licensed band, interference control and charging service through a network-controlled structure, etc. at the same time. In addition, D2D communication based on the cellular telecommunication system can meet the increase of the amount of communication data by various kinds of terminals, by improving efficiency of network using D2D communication without being relayed by the base station.

In addition to the basic advantages of D2D communication based on the cellular telecommunication system, the hierarchical structure between the belonging terminal and the representative terminal in accordance with the embodiments of the present invention provides additional advantages as follows.

The D2D communication method according to the example embodiments of the present invention provides a service with low power consumption because a belonging terminal performs data communication only with an adjacent representative terminal due to a middle gathered structure through the representative terminal. In addition, management of various kinds of nodes and sensors which should be nationally controlled for forest management, reclaimed land management, river management, etc., may be possible through the representative terminal by using broadband telecommunication infrastructure. Also, the conventional wireless sensor network requires a separate method of communication because a conventional sensor network has no way to transmit data to the network. However, the D2D communication method according to the example embodiments of the present invention can overcome the limitation of the conventional sensor network. In addition, the D2D communication method according to the example embodiments of the present invention may be used as a solution for a Proxy machine-to-machine (M2M) device using powerful security of mobile communication compared to that of a sensor network, reliability of data transmission, and speed of data transmission due to low latency.

While the example embodiments of the present invention and their advantages have been described in detail, it should be understood that various changes, substitutions and alterations may be made herein without departing from the scope of the invention.

What is claimed is:

1. A device-to-device (D2D) communication method for a belonging terminal subordinate to a representative terminal to transmit data to the representative terminal, comprising:
performing pairing with the representative terminal;
transmitting a request for scheduling to a serving cell base station of the belonging terminal when a data transmission to the paired representative terminal is required;
receiving an approval for scheduling from the serving cell base station; and
performing the data transmission to the representative terminal based on the approval for scheduling.

2. The method of claim 1, wherein performing the pairing includes transmitting, at the belonging terminal, an identifier acquired by attaching to the serving cell base station to a server which manages pairing information, and receiving the identifier of the representative terminal from the server.

3. The method of claim 1, wherein the request for scheduling is a buffer status report (BSR),
the approval for scheduling is an approval for scheduling through a physical downlink control channel (PDCCH), and
performing the data transmission includes transmitting, at the belonging terminal, a physical uplink shared channel (PUSCH) using radio resources specified by the approval for scheduling.

4. The method of claim 1, wherein the data which the belonging terminal transmits to the representative terminal includes content for the belonging terminal to request information customized for the belonging terminal from the representative terminal.

5. A device-to-device (D2D) communication method for a representative terminal to which at least one belonging terminal is subordinate to transmit data to the belonging terminal, comprising:
performing pairing with the belonging terminal;
transmitting a request for scheduling to a serving cell base station of the representative terminal when a data transmission to the paired belonging terminal is required;
receiving an approval for scheduling from the serving cell base station; and
performing the data transmission to the belonging terminal based on the approval for scheduling.

6. The method of claim 5, wherein performing the pairing includes registering, at the representative terminal, to a server which manages pairing information as a representative terminal with an identifier acquired by attaching to the serving cell base station, and pairing with the belonging terminal which acquires the identifier of the representative terminal from the server.

7. The method of claim 5, wherein the request for scheduling is a buffer status report (BSR),
the approval for scheduling is an approval for scheduling through a physical downlink control channel (PDCCH), and
the data transmission is performed through a physical uplink shared channel (PUSCH) by using radio resources specified by the approval for scheduling.

8. The method of claim 5, wherein the representative terminal broadcasts broadcasting data stored in the representative terminal to the belonging terminals using a group identifier through the D2D communication method.

9. The method of claim 5, wherein the representative terminal serves as an application server which provides an application to the belonging terminals.

10. A device-to-device (D2D) communication method for a representative terminal to which at least one belonging terminal is subordinate to receive data from the belonging terminal, comprising:
transmitting a request for scheduling to a serving cell base station to which the representative terminal belongs when there is data to be received from the belonging terminal;
receiving an approval for scheduling from the serving cell base station; and
receiving the data from the belonging terminal based on the approval for scheduling.

11. The method of claim 10, further comprising collecting the data received from the belonging terminal, processing the collected data through manipulation and analysis, and transmitting the processed data to a data collecting server.

12. The method of claim 10, wherein the request for scheduling is a buffer status report (BSR),
the approval for scheduling is an approval for scheduling through a physical downlink control channel (PDCCH), and
receiving the data includes receiving a physical uplink shared channel (PUSCH) transmitted by the belonging terminal using radio resources specified by the approval for scheduling.

13. A device-to-device (D2D) communication method for a representative terminal to which at least one belonging terminal is subordinate to transmit data to the belonging terminal, comprising:
transmitting a request for scheduling to a serving cell base station of the representative terminal when a data transmission to the belonging terminal is required;
receiving an approval for scheduling from the serving cell base station; and
performing the data transmission to the belonging terminal based on the approval for scheduling.

14. The method of claim 13, wherein the data transmission is a transmission of data including control information on the belonging terminal.

15. The method of claim 13, wherein the request for scheduling is a buffer status report (BSR),
the approval for scheduling is an approval for scheduling through a physical downlink control channel (PDCCH), and
the data transmission is performed through a physical uplink shared channel (PUSCH) by using radio resources specified by the approval for scheduling.
